(19) United States
(12) Patent Application Publication
(10) Pub. No.: US 2022/0398218 A1
(43) Pub. Date: Dec. 15, 2022

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Yutaka IKEDA, Kanagawa (JP)

(73) Assignee: FUJIFILM Business Innovation Corp., Tokyo (JP)

(21) Appl. No.: 17/533,040

(22) Filed: Nov. 22, 2021

(30) Foreign Application Priority Data
Jun. 10, 2021 (JP) 2021-097160

(51) Int. Cl. G06F 16/16; G06F 3/04817; G06F 3/0482

(52) U.S. Cl. CPC G06F 16/168; G06F 3/04817; G06F 3/0482

(57) ABSTRACT

An information processing apparatus includes: a processor configured to: display a corresponding image corresponding to each of plural pieces of data stored in at least one external service; in a case where the plural pieces of data corresponding to the plural displayed corresponding images are respectively stored in the plural external services, display an identification image indicating the external service that stores the displayed data to be superimposed on each of the corresponding images; and in a case where the plural pieces of data corresponding to the plural displayed corresponding images are stored in one external service, not display the identification image to be superimposed on each of the corresponding images.

### CROSS-REFERENCE TO RELATED APPLICATIONS

This application is based on and claims priority under 35 USC 119 from Japanese Patent Application No. 2021-097160 filed Jun. 10, 2021.

### BACKGROUND

### (i) Technical Field

The present invention relates to an information processing apparatus, a non-transitory computer readable medium storing an information processing program, and an information processing method.

### (ii) Related Art

JP3752867B discloses a document processing apparatus including a document icon display section that displays a document icon representing a document, an attribute icon display section that displays an attribute icon representing a print attribute for the document to be superimposed over the document icon in a state of being smaller than the document icon, and a section that allows a user to select any attribute icon in a case where a plurality of attribute icons are displayed on the document icon, in which the print attribute represented by the attribute icon can be selectively set by selecting an attribute icon from the plurality of attribute icons over the document icon.

JP4879866B discloses an image generation apparatus including a relevant information acquisition unit that acquires metadata that is information on a document to be managed, a rule information acquisition unit that acquires rule information that defines a method of highlighting the metadata acquired by the relevant information acquisition unit in a document management image to be generated, and an image generation unit, in which in a case where a software displays the document management image of the document to be managed on a display unit, it is determined whether to generate the document management image in which the metadata of the document is merged with an original document image of the document and the metadata is highlighted or to acquire the document management image from a storage device without generating the document management image, and in a case where it is determined that the software generates the document management image, the image generation unit stores the metadata acquired by the relevant information acquisition unit in advance in the storage device so that the software can generate the document management image by using the metadata, and in a case where it is determined that the software acquires the document management image from the storage device, the image generation unit merges the metadata acquired by the relevant information acquisition unit with the document image in advance, generates the document management image in which the metadata is highlighted, and stores the document management image in the storage device based on the rule information acquired by the rule information acquisition unit.

### SUMMARY

A case where data stored in an external service is displayed as a thumbnail is assumed.

Here, in a case where there are a plurality of external services, it is difficult to know which external service stores the data. Therefore, there is a technology of displaying an image for identifying an external service in which the data is stored, for each data.

Meanwhile, in a case where there are a plurality of pieces of data stored in the same external service, displaying the image for identifying the external service in which the data is stored becomes complicated, for each data.

Aspects of non-limiting embodiments of the present disclosure relate to an information processing apparatus, a non-transitory computer readable medium storing an information processing program, and an information processing method that improve a visibility of a user in a case where there are a plurality of pieces of data stored in the same external service, as compared with a case where an image for identifying the external service in which the data is stored is displayed for each data.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processor configured to: display a corresponding image corresponding to each of a plurality of pieces of data stored in at least one external service; in a case where the plurality of pieces of data corresponding to a plurality of the displayed corresponding images are respectively stored in a plurality of the external services, display an identification image indicating the external service that stores the displayed data to be superimposed on each of the corresponding images; and in a case where the plurality of pieces of data corresponding to the plurality of displayed corresponding images are stored in one external service, not display the identification image to be superimposed on each of the corresponding images.

### BRIEF DESCRIPTION OF THE DRAWINGS

Exemplary embodiment(s) of the present invention will be described in detail based on the following figures, wherein:

FIG. 1 is a schematic configuration diagram of an information processing system according to an exemplary embodiment of the present invention;

FIG. 2 is a schematic block diagram of the image forming apparatus according to the exemplary embodiment of the present invention;

FIG. 3 is a schematic block diagram of a PC, a server, and a cloud server according to the exemplary embodiment of the present invention;

FIGS. 4A to 4C are display examples of a display unit of a PC having a configuration in the related art;

FIG. 5 is a display example of a display unit of the PC according to the exemplary embodiment of the present invention;

FIG. 6 is another display example of the display unit of the PC according to the exemplary embodiment of the present invention;

FIG. 7 is still another display example of the display unit of the PC according to the exemplary embodiment of the present invention;

FIG. 8 is still another display example of the display unit of the PC according to the exemplary embodiment of the present invention; and

FIG. 9 is a flowchart illustrating an example of a process of displaying an icon on a thumbnail, according to the exemplary embodiment of the present invention.

### DETAILED DESCRIPTION

### Exemplary Embodiment

Hereinafter, an example of exemplary embodiments of the present disclosure will be described with reference to the drawings. In each of the drawings, the identical or equivalent components and parts are given the same reference numerals. In addition, in some cases, a dimensional ratio of the drawing is exaggerated for convenience of description and is different from an actual ratio.

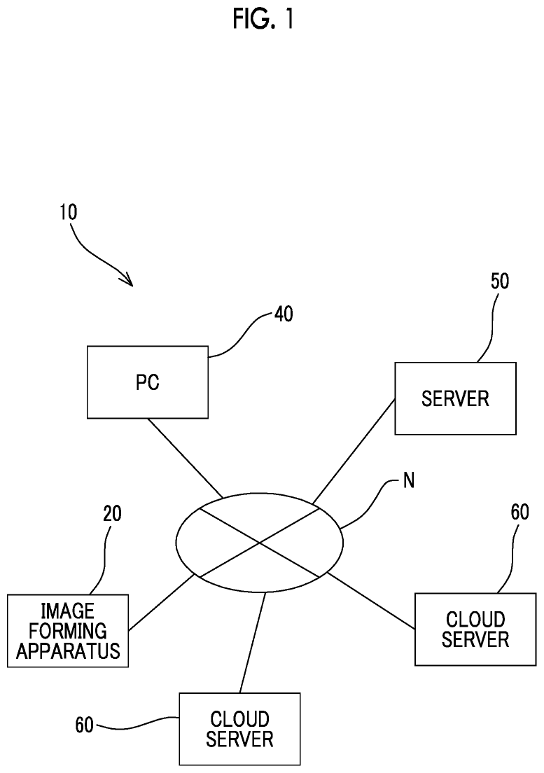

An example of an information processing system 10 according to the present exemplary embodiment will be described with reference to FIG. 1.

FIG. 1 is a diagram illustrating an example of a schematic configuration of the information processing system 10 according to the present exemplary embodiment.

As illustrated in FIG. 1, the information processing system 10 according to the present exemplary embodiment includes an image forming apparatus 20, a personal computer (PC) 40, a server 50, and a plurality of cloud servers 60. The image forming apparatus 20, the PC 40, the server 50, and the cloud server 60 are connected via a network N. For example, a local area network (LAN), a wide area network (WAN), the Internet, and the like are applied to this network N. Here, in the present exemplary embodiment, the server 50 is an example of an information processing apparatus, and the cloud server 60 is an example of an external service. In addition, although the example of the information processing apparatus is the server 50, the exemplary embodiment is not limited to this, and the image forming apparatus 20 or the PC 40 may be used as the information processing apparatus. Further, FIG. 1 illustrates a case where the image forming apparatus 20, the PC 40, and the server 50 are one. Meanwhile, the exemplary embodiment is not limited to this, and a plurality of the image forming apparatuses 20, the PCs 40, and the servers 50 may be connected to the network N. The PC 40 includes an apparatus to be used by a user, such as a tablet-type PC or a smartphone.

The image forming apparatus 20 has various functions such as a printing function, a copying function, a facsimile (FAX) function, or a scanner function.

The cloud server 60 is a server computer that provides a cloud service in the information processing system 10. The cloud service provides a service related to a voucher, which is a record used as evidence such as an “estimate sheet”, “invoice”, and “purchase order”. As an example, the user can use the cloud service to attach voucher data indicating an evidence of edited data to the edited data of the voucher edited by the PC 40, with the scanner function of the image forming apparatus 20.

Further, in the information processing system 10 according to the present exemplary embodiment, the user stores data in the cloud server 60 by using the PC 40, or stores the data in the cloud server 60 by using the scanner function of the image forming apparatus 20. In the present exemplary embodiment, the data to be stored in the cloud server 60 is to be stored via the server 50. That is, in a case where the user selects the cloud server 60 that stores data from the PC 40 or the image forming apparatus 20, the data is stored in the storage unit 54 of the server 50, and then transferred to and stored in the cloud server 60. Here, the data stored in the server 50 by the user is stored in the server 50 even after being transferred to the cloud server 60. Meanwhile, the exemplary embodiment is not limited to this, and the data may be deleted from the server 50.

The user is not limited to selecting the cloud server for storing the data. For example, data such as attributes of the data such as data extension or a file name M or contents of analyzed data obtained by analyzing contents of the data may be stored in a predetermined cloud server 60 among the plurality of cloud servers 60. Further, the cloud server 60 that stores the data may be separated, by data for mail merge and the data stored by the scanner function from the image forming apparatus 20.

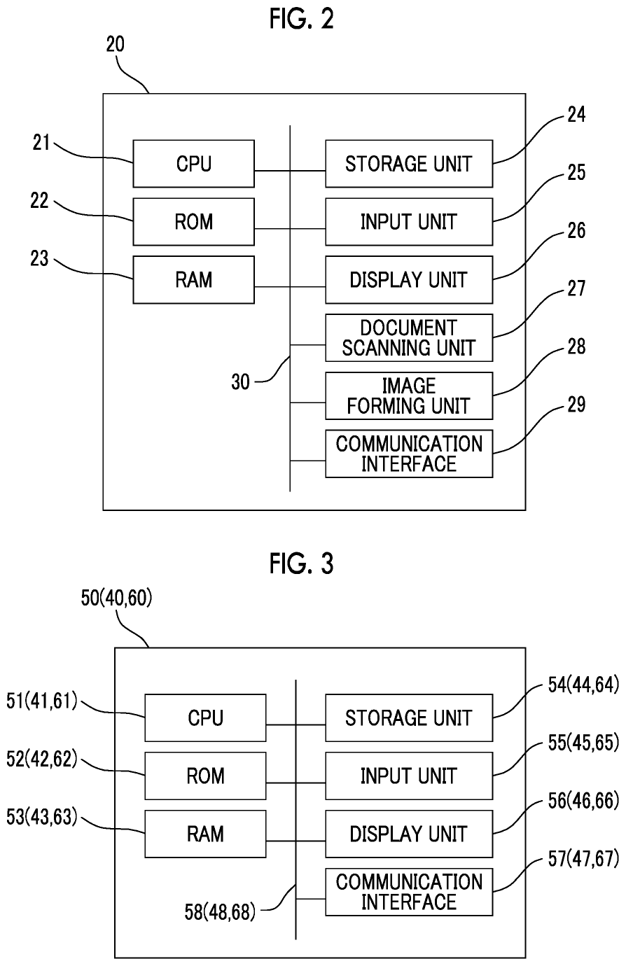

FIG. 2 is a block diagram illustrating a hardware configuration of the image forming apparatus 20 according to the present exemplary embodiment.

As illustrated in FIG. 2, the image forming apparatus 20 includes a central processing unit (CPU) 21 which is an example of a processor, a read only memory (ROM) 22, a random access memory (RAM) 23, a storage unit 24, an input unit 25, a display unit 26, a document reading unit 27, an image forming unit 28, and a communication interface 29. The respective configurations are communicably connected to each other via a bus 30.

The CPU 21 is a central arithmetic processing unit, and executes various programs and controls each unit. That is, the CPU 21 reads the program from the ROM 22 or the storage unit 24, and executes the program by using the RAM as a work area. The CPU 21 controls each of the configurations described above, and performs various arithmetic processes according to the program recorded in the ROM 22 or the storage unit 24. In the present exemplary embodiment, the program is stored in the ROM 22 or the storage unit 24.

The ROM 22 stores various programs and various types of data. The RAM 23 temporarily stores a program or data as a work area. The storage unit 24 is configured with a hard disk drive (HDD) or a solid state drive (SSD), and stores various programs and various types of data including an operating system.

The input unit 25 includes a pointing device such as a mouse and a keyboard, and is used for performing various inputs. The input unit 25 is used for executing a function such as an instruction to start printing, as will be described below. Further, in the present exemplary embodiment, the touch panel type display unit 26 functions as the input unit 25.

The display unit 26 is, for example, a liquid crystal display. The display unit 26 displays various types of information based on a control of the CPU 21. Further, the display unit 26 adopts a touch panel method, and also functions as the input unit 25.

The document reading unit 27 takes a document placed on a paper feeding tray of an automatic feeding apparatus (not illustrated) provided at an upper portion of the image forming apparatus 20 one by one, and optically scans the taken document to obtain image information. Alternatively, the document reading unit 27 optically scans a document placed on a table such as a platen glass to obtain image information.

Here, the image information of the document scanned by the document reading unit 27 is saved in the storage unit 24 of the image forming apparatus 20, printed by the image forming unit 28 which will be described below, or transmitted to another image forming apparatus having a facsimile (FAX) function by the communication interface 29 which will be described below.

The image forming unit 28 forms, that is, prints print data included in a print job obtained from the PC 40 connected via the network N or an image based on the image information obtained by scanning with the document reading unit 27 on a recording medium such as paper.

The communication interface 29 is connected to the network N, and is for the image forming apparatus 20 to communicate with other devices such as the PC 40, the server 50, or the cloud server 60.

Further, the communication interface 29 connects the image forming apparatus 20 to a public line, and transmits and receives the image information obtained by scanning with the document reading unit 27 to the other image forming apparatus having the facsimile (FAX) function.

FIG. 3 is a block diagram illustrating a hardware configuration of the PC 40, the server 50, and the cloud server 60. Since the PC 40, the server 50, and the cloud server 60 basically have a general computer configuration, the server 50 will be described as a representative.

As illustrated in FIG. 3, the server 50 includes a CPU 51, a ROM 52, a RAM 53, a storage unit 54, an input unit 55, a display unit 56, and a communication interface 57. The respective configurations are communicably connected to each other via a bus 58.

The CPU 51 is a central arithmetic processing unit, and executes various programs and controls each unit. That is, the CPU 51 reads the program from the ROM 52 or the storage unit 54, and executes the program by using the RAM as a work area. The CPU 51 controls each of the configurations described above, and performs various arithmetic processes according to the program recorded in the ROM 52 or the storage unit 54. In the present exemplary embodiment, the program and various types of data are stored in the ROM 52 or the storage unit 54.

The ROM 52 stores various programs and various types of data. The RAM 53 temporarily stores a program or data as a work area. The storage unit 54 is configured with an HDD or an SSD, and stores various programs including an operating system and various types of data. The storage unit 54 of the server 50 stores various types of data transmitted from the image forming apparatus 20 and the PC 40.

The input unit 55 includes a pointing device such as a mouse and a keyboard, and is used for performing various inputs.

The display unit 56 is, for example, a liquid crystal display. The display unit 56 displays various types of information based on a control of the CPU 51.

The communication interface 57 is for communicating with other devices such as the image forming apparatus 20, the server 50, and the cloud server 60. For example, standards such as the Internet, an intranet, Ethernet (registered trademark), FDDI, and Wi-Fi (registered trademark) are used.

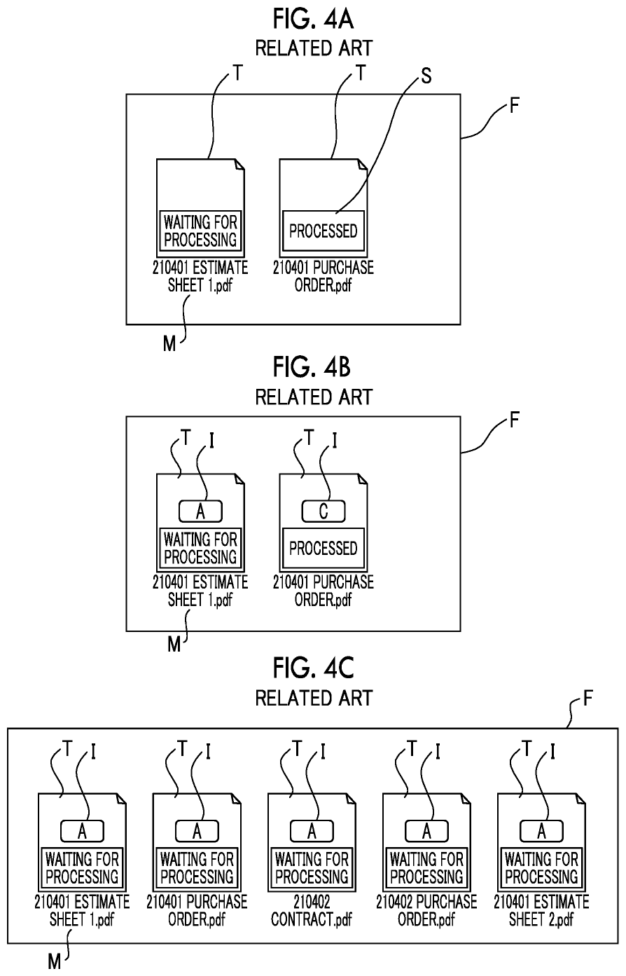

The exemplary embodiment of the present invention will be described in comparison with a display example of the display unit 46 of the PC 40 in a configuration in the related art in a case where the exemplary embodiment of the present invention is not used, by using the FIGS. 4A to 6.

Further, a case where a thumbnail T of data is displayed as an example of a corresponding image corresponding to the data will be described. Here, the corresponding image corresponding to the data is not limited to the thumbnail T, and may be a software icon capable of opening the data or another image. The thumbnail T is created and displayed by the CPU 51 of the server 50, and may be created and displayed by the CPU 41 of the PC 40.

FIGS. 4A to 4C are display examples of the display unit 46 of the PC 40 in a configuration in the related art in a case where a folder F of the server 50 in which data from the PC 40 is stored is accessed. Here, the folder F in which the data is stored is created in the storage unit 54 of the server 50.

As illustrated in FIG. 4A, a status S and the file name M are displayed in a display of the thumbnail T of data. Here, the status S indicates a state of a data process (for example, upload process or the like) such as “waiting for processing”, “processed”, “in process”, or “error”, and may not displayed to be superimposed on the thumbnail T.

In a case of the display example in FIG. 4A, it is unknown which cloud server 60 among the plurality of cloud servers 60 stores the data. Therefore, as illustrated in FIG. 4B, in displaying the thumbnail T of the data, it is considered that an icon I indicating the cloud server 60 in which the data is stored among the plurality of cloud servers 60 is displayed to be superimposed, for each thumbnail T. Here, the icon I is an example of an identification image. The icon I of “A” indicates that the data is stored in a cloud server A, and the icon I of “B” indicates that the data is stored in the cloud server B, among the plurality of cloud servers 60. Meanwhile, as illustrated in FIG. 4C, in a case where all the data on which the thumbnail T is displayed is stored in the same cloud server 60 and the same icon I (the icon I named “A” indicating the cloud server A) is displayed on all the thumbnails T, the amount of information to be displayed becomes too large, and the display becomes complicated, so it takes time for the user to recognize the data. Further, since all the data is stored in the same cloud server 60, a need to display the icon I on the thumbnail T is reduced.

Therefore, the present exemplary embodiment is to improve a visibility of the user in a case where a plurality of pieces of data are stored in the same cloud server 60, for each data, as compared with the case where the icon I for identifying the cloud server 60 in which the data is stored is displayed.

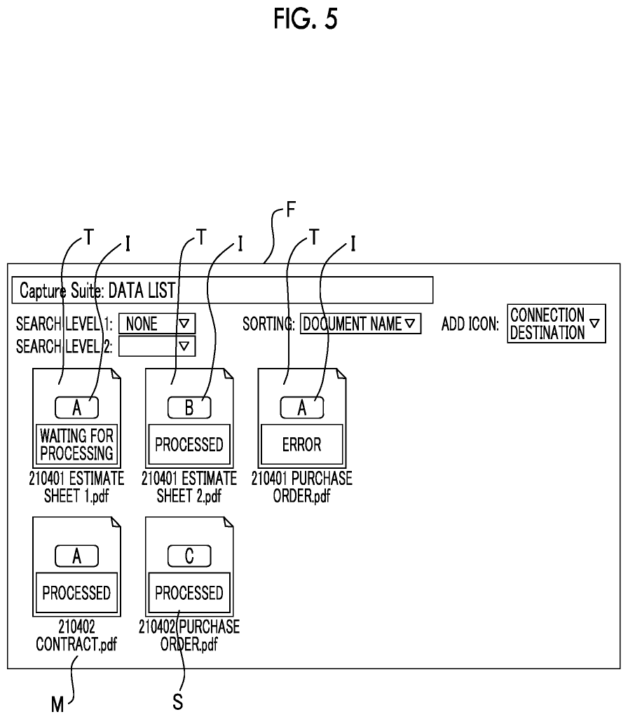

FIG. 5 illustrates a display example of the display unit 46 of the PC 40 in a case where a folder of the server 50 in which data from the PC 40 is stored accessed in a case where the data stored in the server 50 is distributed and stored in the plurality of cloud servers 60, in the present exemplary embodiment.

In the present exemplary embodiment, as illustrated in FIG. 5, in a case where a plurality of pieces of data corresponding to the plurality of displayed thumbnails T are respectively stored in the plurality of cloud servers 60 (in the example in FIG. 5, the cloud server A, the cloud server B, and a cloud server C), the icon I indicating the cloud server 60 that stores the displayed data is displayed to be superimposed for each thumbnail T. Specifically, in the example in FIG. 5, it can be determined from the icon I that data having the file name M of “210401 estimate sheet 1.pdf” is stored in the cloud server A among the cloud servers 60, data having the file name M of “210401 estimate sheet 2.pdf” is stored in the cloud server B among the cloud servers 60, and data having the file name M of “210401 purchase order.pdf” is stored in the cloud server C among the cloud servers 60, respectively.

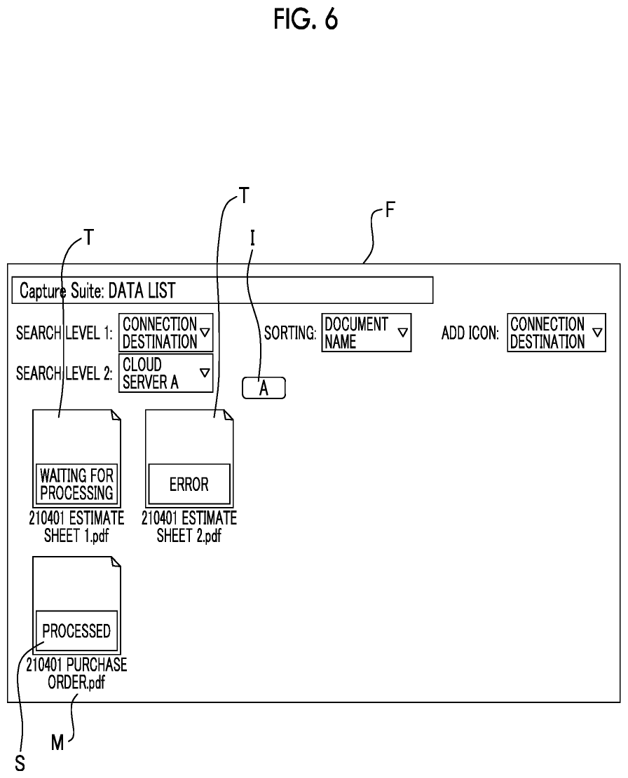

FIG. 6 is a display example of the display unit 46 of the PC 40 in a case where data stored in the server 50 is only data stored in one cloud server 60, in the present exemplary embodiment.

In the present exemplary embodiment, as illustrated in FIG. 6, in a case where a plurality of data corresponding to the plurality of displayed thumbnails T are stored in one cloud server 60 (the cloud server A in the example in FIG. 6), the icon I is not displayed to be superimposed for each thumbnail T. Then, in a case where the icon I is not displayed to be superimposed on each thumbnail T, one icon I is displayed at a location other than a location at which the icon I is superimposed on the thumbnail T. In the present exemplary embodiment, the location other than the location at which the icon I is superimposed on the thumbnail T is an upper side (a menu portion) of the folder F. In the example in FIG. 6, one icon I named “A” indicating that the data is stored in the cloud server A is displayed in the menu portion of the folder F.

The exemplary embodiment is not limited to the case where one icon I is displayed, and the thumbnail T may be displayed at a plurality of locations other than the location at which the icon I is superimposed on the thumbnail T, as long as the display is not complicated.

Further, in the present exemplary embodiment, the icon I displayed in the menu portion of the folder F is configured with the same image as the icon I displayed superimposed on the thumbnail T, and is not limited thereto.

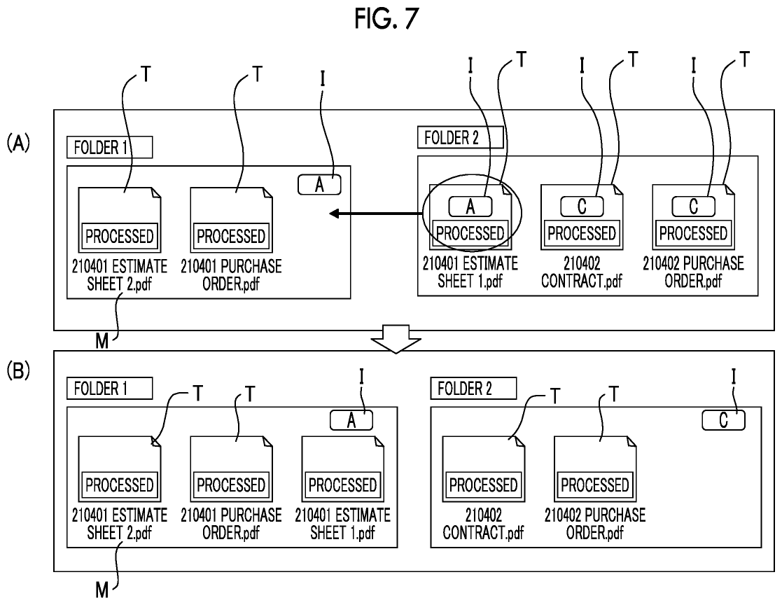

FIG. 7 is explanatory diagram illustrating a display of the icon I in a case where data is moved between folders. FIG. 7A is an explanatory diagram illustrating a display of the thumbnail T and the icon I before the thumbnail T of the file name M of “210401 estimate sheet 1.pdf” is moved from the folder F (a folder 2 on the right side in FIG. 7A) in which data stored in the plurality of cloud servers 60 is stored to the folder F (a folder 1 on the left side in FIG. 7A) in which only data stored in one cloud server 60 is stored, by dragging and dropping the thumbnail T. FIG. 7B is an explanatory diagram illustrating a display of the thumbnail T and the icon I after moving the thumbnail T of the file name M “210401 estimate sheet 1.pdf” from the folder 2 to the folder 1 by dragging and dropping the thumbnail T.

As illustrated in FIG. 7, as a result of moving the thumbnail T displayed in the folder F (the folder 2) to the other folder F (the folder 1), in a case where a plurality of pieces of data corresponding to the thumbnails T displayed in the other folder F (the folder 1) are stored in one cloud server 60, the icon I is not displayed to be superimposed for each thumbnail T in the other folder F (the folder 1). That is, in the folder 1, since all the data is stored in the same cloud server A among the cloud servers 60, the icon I is not displayed to be superimposed on the thumbnail T. Specifically, in a case of moving from the folder F (the folder 2) in which the data stored in the plurality of cloud servers 60 (the cloud server A and the cloud server C) is stored to the other folder F (the folder 1) in which only the data stored in one cloud server 60 (the cloud server A) is stored, the icon I (the icon I named “A” indicating being stored in the cloud server A) displayed to be superimposed on the moved thumbnail T of the file name M of “210401 estimate sheet 1.pdf” is not displayed. Further, in the folder F (the folder 2) in which only the data stored in one cloud server 60 is stored, the icon I displayed to be superimposed on the thumbnail T (the icon I named “C” indicating being stored in the cloud server C) is deleted and is not displayed.

Further, although not illustrated, in a case where as a result of moving the thumbnail T displayed in the folder F to the other folder F, the number of cloud servers 60 corresponding to the thumbnail T displayed in the other folder F is changed from one to a plurality, the icon I is displayed to be superimposed on the thumbnail T in the other folder F.

Further, in a case where as a result of moving the thumbnail T displayed in the folder F to the other folder F, only one thumbnail T is displayed in one folder F, there is only one cloud server 60, so that the icon I is not displayed to be superimposed on the thumbnail T. Meanwhile, there is only one thumbnail T, so that the icon I may be displayed to be superimposed on the thumbnail T in the folder F. That is, since there is only one data, the display is not complicated even in a case where the icon I is superimposed on the thumbnail T, and it is possible to improve the convenience of the user by displaying the cloud server 60 in which the data is stored for understanding.

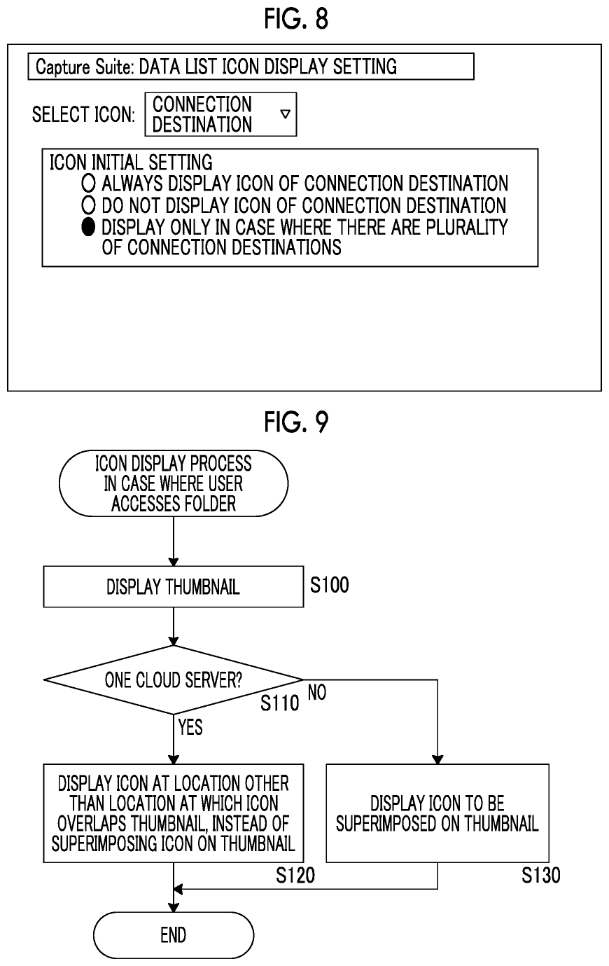

Further, it may be possible to determine in advance whether or not to display the icon I on the thumbnail T. For example, as illustrated in FIG. 8, the user can select an initial setting for displaying the icon I among three conditions of “always display icon of connection destination”, “do not display icon of connection destination”, and “display only in a case where there are a plurality of connection destinations”. In the exemplary embodiment described above, a case where “display only in a case where there are a plurality of connection destinations” is selected will be described as an example.

Next, an action of the information processing system 10 will be described.

FIG. 9 is a flowchart illustrating an example of a flow of a process in which the CPU 51 of the server 50 displays the thumbnail T and displays the icon I to be superimposed on the thumbnail T in a case where the user accesses the folder F of the server 50 by using the PC 40.

In step S100 illustrated in FIG. 9, the CPU 51 of the server 50 displays the thumbnail T of data stored in the folder F accessed by the user. Then, the process proceeds to the next step S110.

In step S110, the CPU 51 of the server 50 determines whether or not the data stored in the folder F is only data stored in one cloud server 60. In a case where it is determined that the data is only the data stored in one cloud server 60, the process proceeds to the next step S120.

In step S120, the CPU 51 of the server 50 does not display the icon I to be superimposed on the thumbnail T, and displays one icon I at a location other than a location at which the icon I is superimposed on the thumbnail T. Then, the process is completed.

On the other hand, in step S110 described above, in a case where it is determined that the data is not only the data stored in one cloud server 60, that is, in a case where the data is stored in the plurality of cloud servers 60, the process proceeds from step S110 to step S130.

In step S130, the CPU 51 of the server 50 displays the icon I to be superimposed on the thumbnail T. Then, the process is completed.

Here, the flowchart illustrated in FIG. 9 is also applicable in the case of moving from the folder F in which the data stored in the plurality of cloud servers 60 is stored, to the other folder in which only the data stored in one cloud server 60 is stored. On the contrary, the flowchart is also applicable in the case of moving from the folder F in which only the data stored in one cloud server 60 is stored to the folder F in which the data stored in the plurality of cloud servers 60 is stored. That is, in a case where the data stored in the folder F is stored in the plurality of cloud servers 60, the icon I is not displayed on the thumbnail T, and in a case where the data stored in the folder F is stored in one cloud server 60, the icon I is displayed to be superimposed on the thumbnail T.

The exemplary embodiment of the present invention is not limited to the exemplary embodiment described above, and various modifications and applications are possible without departing from the gist of the exemplary embodiment of the present invention.

In the exemplary embodiment, an aspect in which the program is stored (installed) in the ROM or the storage unit in advance is described, and the exemplary embodiment is not limited to this. The program may be recorded on a recording medium such as a compact disc only memory (CD-ROM), a digital versatile disc read only memory (DVD-ROM), or a universal serial bus (USB) memory. In addition, the program may be downloaded from an external apparatus via the network N.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
display a corresponding image corresponding to each of a plurality of pieces of data stored in at least one external service;
in a case where the plurality of pieces of data corresponding to a plurality of the displayed corresponding images are respectively stored in a plurality of the external services, display an identification image indicating the external service that stores the displayed data to be superimposed on each of the corresponding images; and
in a case where the plurality of pieces of data corresponding to the plurality of displayed corresponding images are stored in one external service, not display the identification image to be superimposed on each of the corresponding images.

2. The information processing apparatus according to claim 1, wherein the processor is configured to:
in a case where the identification image is not displayed to be superimposed on each of the corresponding images, display one identification image at a location other than a location at which the identification image is superimposed on the corresponding image.

3. The information processing apparatus according to claim 1,
wherein the plurality of corresponding images are classified into a plurality of folders and individually displayed in the plurality of folders, and
the processor is configured to:
in a case where as a result of moving the corresponding image displayed in one folder to another folder, a plurality of pieces of the data corresponding to the corresponding image displayed in the other folder are stored in one external service, not display the identification image to be superimposed on each of the corresponding images in the other folder.

4. The information processing apparatus according to claim 2,
wherein the plurality of corresponding images are classified into a plurality of folders and individually displayed in the plurality of folders, and
the processor is configured to:
in a case where as a result of moving the corresponding image displayed in one folder to another folder, a plurality of pieces of the data corresponding to the corresponding image displayed in the other folder are stored in one external service, not display the identification image to be superimposed on each of the corresponding images in the other folder.

5. The information processing apparatus according to claim 3, wherein the processor is configured to:
in a case where as the result of moving the corresponding image displayed in the one folder to the other folder, only one corresponding image is displayed in the one folder, display the identification image to be superimposed on the corresponding image in the one folder.

6. The information processing apparatus according to claim 4, wherein the processor is configured to:
in a case where as the result of moving the corresponding image displayed in the one folder to the other folder, only one corresponding image is displayed in the one folder, display the identification image to be superimposed on the corresponding image in the one folder.

7. The information processing apparatus according to claim 3, wherein the processor is configured to:
in a case where as the result of moving the corresponding image displayed in the one folder to the other folder, the number of external services corresponding to the corresponding image displayed in the other folder is changed from one to a plurality, not display the identification image to be superimposed on the corresponding image in the other folder.

8. The information processing apparatus according to claim 4, wherein the processor is configured to:
in a case where as the result of moving the corresponding image displayed in the one folder to the other folder, the number of external services corresponding to the corresponding image displayed in the other folder is changed from one to a plurality, not display the identification image to be superimposed on the corresponding image in the other folder.

9. The information processing apparatus according to claim 5, wherein the processor is configured to:
in a case where as the result of moving the corresponding image displayed in the one folder to the other folder, the number of external services corresponding to the corresponding image displayed in the other folder is changed from one to a plurality, not display the identification image to be superimposed on the corresponding image in the other folder.

10. The information processing apparatus according to claim 6, wherein the processor is configured to:
in a case where as the result of moving the corresponding image displayed in the one folder to the other folder, the number of external services corresponding to the corresponding image displayed in the other folder is changed from one to a plurality, not display the identification image to be superimposed on the corresponding image in the other folder.

11. The information processing apparatus according to claim 1, wherein the processor is configured to:
determine in advance whether or not to display the identification image to be superimposed on the corresponding image.

12. The information processing apparatus according to claim 2, wherein the processor is configured to:
determine in advance whether or not to display the identification image to be superimposed on the corresponding image.

13. The information processing apparatus according to claim 3, wherein the processor is configured to:
determine in advance whether or not to display the identification image to be superimposed on the corresponding image.

14. The information processing apparatus according to claim 4, wherein the processor is configured to:
determine in advance whether or not to display the identification image to be superimposed on the corresponding image.

15. The information processing apparatus according to claim 5, wherein the processor is configured to:
determine in advance whether or not to display the identification image to be superimposed on the corresponding image.

16. The information processing apparatus according to claim 6, wherein the processor is configured to:
determine in advance whether or not to display the identification image to be superimposed on the corresponding image.

17. The information processing apparatus according to claim 7, wherein the processor is configured to:
determine in advance whether or not to display the identification image to be superimposed on the corresponding image.

18. The information processing apparatus according to claim 8, wherein the processor is configured to:
determine in advance whether or not to display the identification image to be superimposed on the corresponding image.

19. A non-transitory computer readable medium storing an information processing program causing a computer to execute a process comprising:
displaying a corresponding image corresponding to each of a plurality of pieces of data stored in at least one external service;
displaying, in a case where the plurality of pieces of data corresponding to a plurality of the displayed corresponding images are respectively stored in a plurality of the external services, an identification image indicating the external service that stores the displayed data to be superimposed on each of the corresponding images; and
not displaying, in a case where the plurality of pieces of data corresponding to the plurality of displayed corresponding images are stored in one external service, the identification image to be superimposed on each of the corresponding images.

20. An information processing method comprising:
displaying a corresponding image corresponding to each of a plurality of pieces of data stored in at least one external service;
displaying, in a case where the plurality of pieces of data corresponding to a plurality of the displayed corresponding images are respectively stored in a plurality of the external services, an identification image indicating the external service that stores the displayed data to be superimposed on each of the corresponding images; and
not displaying, in a case where the plurality of pieces of data corresponding to the plurality of displayed corresponding images are stored in one external service, the identification image to be superimposed on each of the corresponding images.
